(19) United States
(12) Patent Application Publication
(10) Pub. No.: US 2022/0148031 A1
(43) Pub. Date: May 12, 2022

(54) TRI-PARTY PROCESS FLOW FOR CONTROL TRIALS ANALYTICS

(71) Applicant: Mastercard International Incorporated, Purchase, NY (US)

(72) Inventors: Paul Fischer, San Francisco, CA (US); Shankhayan Dutta, San Francisco, CA (US); Kyu Hyeon Kim, San Francisco, CA (US); Jessie Thornburg, Oakland, CA (US)

(73) Assignee: Mastercard International Incorporated, Purchase, NY (US)

(21) Appl. No.: 17/524,408

(22) Filed: Nov. 11, 2021

Related U.S. Application Data
(60) Provisional application No. 63/112,409, filed on Nov. 11, 2020.

(51) Int. Cl. G06Q 30/02; G06Q 40/02; G06F 16/245

(52) U.S. Cl. CPC G06Q 30/0246; G06F 16/245; G06Q 40/025

(57) ABSTRACT

Systems and methods for filtering data representative of consumers targeted for marketing campaigns that include receiving, at a first computer system operating on behalf of a payment card network, a first data set comprising pseudonymized data of a plurality of consumers derived from respective consumer files, the pseudonymized data of each consumer including a unique artificial identifier for the consumer, the first data set being received from a second, independent computer system storing keys configured to re-identify at least some of the pseudonymized data of the first data set; comparing, at the first computer system, the pseudonymized data of each of the consumers with payment card network criteria to generate a second data set comprising a subset of the first data set corresponding to a qualifying subset of the consumers and unique artificial identifiers included in the first data set; and transmitting the second data set from the first computer system to the second computer system.

### CROSS REFERENCE TO RELATED APPLICATIONS

This application claims the priority benefit of identically-titled U.S. Provisional Patent Application Ser. No. 63/112,409 filed Nov. 11, 2020, the entire disclosure of which is incorporated herein by reference.

### FIELD OF THE INVENTION

The present invention generally relates to computer-implemented methods and systems for enabling analytics of pseudonymized data for filtering data sets related to marketing campaigns.

### BACKGROUND

Financial institutions, such as banks, often desire to perform targeted marketing campaigns to generate business. To avoid targeting consumers who would not qualify for certain products or offers and therefore to avoid waste, financial institutions pre-screen consumers by sending criteria to consumer reporting agencies and receiving consumer reports on consumers that meet the criteria. However, the Fair Credit Reporting Act (FCRA) dictates that only firm offers of credit may be used to access consumer reports for transactions not initiated by consumers. In other words, once the financial institution has received a list of qualified consumers, the financial institution generally must make an offer of credit to the qualified consumers.

Such requirements make it difficult for financial institutions and related entities to test the effectiveness of marketing campaigns.

The background discussion is intended to provide information related to the present invention which is not necessarily prior art.

### BRIEF SUMMARY

Embodiments of the present technology relate to computer-implemented methods and systems comprising computer-readable media for enabling incremental analysis with true look-alike control groups in connection with marketing campaigns relating to offers of credit.

In one aspect, a computer-implemented method of filtering targets for marketing campaigns is provided. The method comprises receiving, at a first computer system operating on behalf of a payment card network, a first data set comprising pseudonymized data of a plurality of consumers derived from respective consumer files, the pseudonymized data of each consumer represented in the first data set including a unique artificial identifier, the first data set being received from a second, independent computer system storing keys configured to re-identify at least some of the pseudonymized data of the first data set; comparing, at the first computer system, the pseudonymized data of each of the consumers with payment card network criteria to generate a second data set comprising a subset of the first data set corresponding to a qualifying subset of the consumers and unique artificial identifiers included in the first data set; and transmitting the second data set from the first computer system to the second computer system.

In another aspect, a computer-implemented method of providing targets for marketing campaigns is provided. The method comprises receiving, at a first computer system operating on behalf of a consumer reporting agency, financial institution criteria received from a second, independent computer system operating on behalf of a financial institution; comparing, at the first computer system, data of a plurality of consumers derived from their respective consumer files with the financial institution criteria to generate an initial data set comprising a subset of the data of the plurality of consumers corresponding to a qualifying subset of the plurality of consumers; pseudonymizing, at the first computer system, the data associated with each consumer of the initial data set with a key to generate a first data set, the pseudonymized data of each consumer represented in the initial data set including a unique artificial identifier; transmitting the first data set from the first computer system to a third, independent computer system operating on behalf of a payment card network; receiving, at the first computer system from the third computer system, a second data set comprising a subset of the first data set corresponding to a qualifying subset of the consumers and unique artificial identifiers included in the first data set; re-identifying, at the first computer system, consumers in the second data set using the key to generate a third data set; and transmitting the third data set to the second computer system.

In another aspect, a computer system operating on behalf of a payment card network and configured to filter targets for marketing campaigns is provided. The computer system comprises a first computer system comprising a non-transitory computer-readable medium having computer readable program code for instructing a processing element to perform the following steps: receive a first data set comprising pseudonymized data of a plurality of consumers derived from their respective consumer files, the pseudonymized data of each consumer including a unique artificial identifier for the consumer, the first data set being received from a second, independent computer system storing keys configured to re-identify at least some of the pseudonymized data of the first data set; compare the data of each of the consumers with payment card network criteria to generate a second data set comprising a subset of the first data set corresponding to a qualifying subset of the consumers and unique artificial identifiers included in the first data set; and transmit the second data set from the first computer system to the second computer system.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which embodiments of a system may be utilized for providing targets for marketing campaigns;

FIG. 2 is a flowchart of various components, and steps or actions performed via, exemplary systems for providing targets for marketing campaigns;

FIGS. 3-6 illustrate various components of exemplary computer systems shown in block schematic form that may be used with the system of FIG. 1; and

FIG. 7 illustrates at least a portion of the steps of an exemplary computer-implemented method for providing targets for a marketing campaign.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The term “card payment network,” used herein, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated in connection with the following service marks: MASTERCARD®, VISA®, DISCOVER®, AMERICAN EXPRESS®, and the like.

The term “consumer file” means the information on a corresponding consumer recorded and retained by a consumer reporting agency, regardless of how the information is stored.

The term “consumer report” means any written, oral, or other communication of any information by a consumer reporting agency bearing on a consumer's credit worthiness, credit standing, credit capacity, character, general reputation, personal characteristics, or mode of living which is used or expected to be used or collected in whole or in part for the purpose of serving as a factor in establishing the consumer's eligibility for credit or insurance to be used primarily for personal, family, or household purposes, employment purposes, or any other purpose outlined in 15 U.S.C. § 1681b as it exists at the time of filing of the instant (priority) application.

The term “consumer reporting agency” means any person which, for monetary fees, dues, or on a cooperative nonprofit basis, regularly engages in whole or in part in the practice of assembling or evaluating consumer credit information or other information on consumers for the purpose of furnishing consumer reports to third parties, and which uses any means or facility of interstate commerce for the purpose of preparing or furnishing consumer reports.

The term “financial institution” means a State or National bank, a State or Federal savings and loan association, a mutual savings bank, a State or Federal credit union, or any other person that, directly or indirectly, holds a transaction account belonging to a consumer.

The term “firm offer of credit or insurance” means any offer of credit or insurance to a consumer that will be honored if the consumer is determined, based on information in a consumer report on the consumer, to meet the specific criteria used to select the consumer for the offer, except that the offer may be further conditioned on the consumer being determined, based on information in the consumer's application for the credit or insurance, to meet specific criteria bearing on credit worthiness or insurability, as applicable, that are established before selection of the consumer for the offer and for the purpose of determining whether to extend credit or insurance pursuant to the offer.

A computer system “operating on behalf of” a juristic entity comprises one or more computing devices operating alone or as part of one or more computer networks under the direction and control of the entity, including computer systems owned by the entity or owned or operated by third party service providers and hosts under the direction and for the benefit of the entity. In one or more embodiments, a computer system operating on behalf of a financial institution is not operating on behalf of any of a card payment network, consumer reporting agency, or mail house. In one or more embodiments, a computer system operating on behalf of a card payment network is not operating on behalf of any of a financial institution, consumer reporting agency, or mail house. In one or more embodiments, a computer system operating on behalf of a consumer reporting agency is not operating on behalf of any of a card payment network, financial institution, or mail house. In one or more embodiments, a computer system operating on behalf of a mail house is not operating on behalf of any of a card payment network, consumer reporting agency, or financial institution. In one or more embodiments a computer system that is not operating on behalf of an entity may not be lawfully accessed by the entity for its business purposes except in the discretion of another, independent entity.

In an example scenario, a financial institution may desire to perform a marketing campaign with firm offers of credit to consumers satisfying certain criteria consistent with a product offered in the marketing campaign. The criteria may be associated with the type of credit or credit card to be offered to the consumer. For example, the criteria may include a particular credit score range, presence or absence of recent bankruptcy declarations, whether a consumer is already a customer of the financial institution, or other factors. The financial institution may send the criteria to a consumer reporting agency. The consumer reporting agency may compare consumer files to the criteria to generate a list of matching consumers, and may send corresponding consumer reports to the financial institution. The financial institution is thereafter generally obligated to send offers of credit to the qualifying consumers, and may be prohibited from further screening or narrower selections from among the qualifying consumers. For example, this may prohibit further screening based on other data for incremental analysis and/or selection of a control group from the list of qualifying consumers.

The present embodiments may relate to enabling incremental analysis of criteria and/or data used in marketing campaigns involving firm offers of credit and enabling the use of control groups within corresponding legal confines (e.g., without violating the FCRA). Data associated with such control groups may be compared with data of consumers targeted in a marketing campaign to determine the performance of the marketing campaign.

Embodiments of the present invention provide methods, systems, and computer program products for preserving a control group. A financial institution may send financial institution criteria to a first computer system operating on behalf of a consumer reporting agency. The consumer reporting agency may receive the financial institution criteria at the first computer system and compare, via the first computer system, data of a plurality of consumers derived from respective consumer files with the financial institution criteria to generate an initial data set comprising a subset of the data of the plurality of consumers corresponding to a qualifying subset of the plurality of consumers. The first computer system may pseudonymize the data associated with each consumer of the initial data set with a key to generate a first data set. The pseudonymized data of each consumer represented in the first data set may include a unique artificial identifier for the consumer. The first data set may be transmitted to a second computer system operating on behalf of a payment card network. The payment card network may receive, at the second computer system, the first data set and designate a control group comprising one or more of the consumers represented in the first data set.

In one or more embodiments, the second computer system may apply payment card network criteria for incremental analysis purposes. The payment card network may receive, at the second computer system, the first data set and compare, at the second computer system, the pseudonymized data of each of the consumers with payment card network criteria to generate a second data set comprising a subset of the first data set corresponding to a qualifying subset of the consumers and unique artificial identifiers included in the first data set. The payment card network transmits the second data set from the second computer system to the first computer system.

The consumer reporting agency receives, at the first computer system from the second computer system, the second data set and re-identifies consumers in the second data set using the key to generate a third data set. The consumer reporting agency transmits the third data set from the first computer system to a third computer system operating on behalf of the financial institution and optionally a fourth computer system operating on behalf of a mail house. The consumers of the third data set are then sent firm offers of credit.

The third computer system compiles first performance data reflecting actions or omissions of at least some of the consumers represented in the third data set but not represented in the control group. The third computer system may also compile second performance data reflecting actions or omissions of at least some of the consumers represented in the control group. The financial institution transmits the first performance data and the second performance data from the third computer system to the first computer system.

The consumer reporting agency receives the first performance data and the second performance data at the first computer system. The first computer system may pseudonymize the first performance data at least in part by including the unique artificial identifiers corresponding to the at least some of the consumers represented in the third data set that are not represented in the control group. The first computer system may also pseudonymize the second performance data at least in part by including the unique artificial identifiers corresponding to the at least some of the consumers represented in the control group. The consumer reporting agency may transmit the pseudonymized first performance data and the pseudonymized second performance data from the first computer system to the second computer system.

The payment card network may receive the pseudonymized first performance data and the pseudonymized second performance at the second computer system and may perform incremental analysis on the performance data. For example, the second computer system may compare the first performance data against the second performance data to generate an indicator of the efficacy of the marketing campaign. Additionally, the second computer system may determine a correlation between at least some of the pseudonymized data corresponding to the consumers reflected in the second data set but not reflected in the control group, on the one hand, and at least some of the first performance data corresponding to the consumers reflected in the second data set but not reflected in the control group, on the other hand, to generate a profile.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### EXEMPLARY SYSTEM

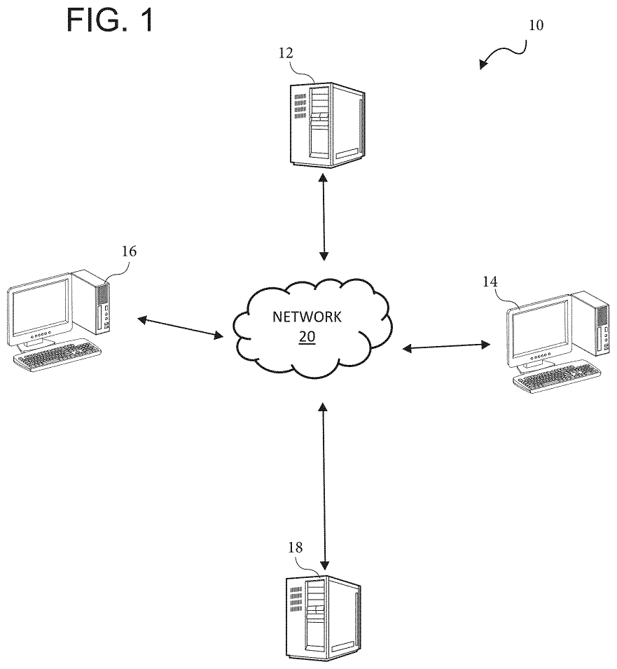

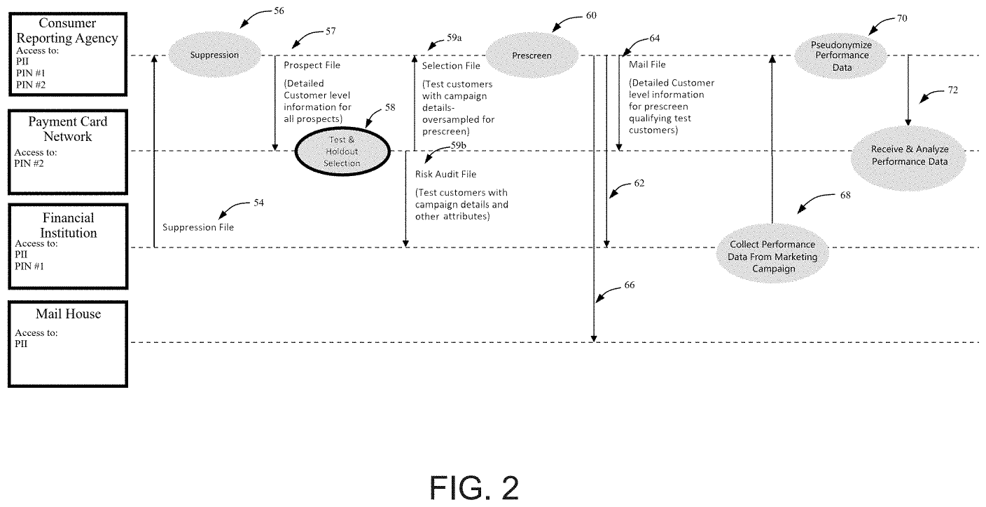

FIG. 1 illustrates an exemplary representation of an environment in which embodiments of a system 10 may be utilized for creation of a control group for incremental analysis of marketing campaigns involving offers of credit. FIG. 2 illustrates a flowchart of steps of actions performed via the system 10 for creating a control group and performing incremental analysis. The system 10 may include a first computer system 12 operating on behalf of the consumer reporting agency, a second computer system 14 operating on behalf of a payment card network, a third computer system 16 operating on behalf of a financial institution, a fourth computer system 18 operating on behalf of a mail house, and a network 20 accessible by the computer systems 12, 14, 16, 18.

The computer systems 12, 14, 16, 18 may be embodied by one or more application servers, database servers, file servers, mail servers, print servers, web servers, desktop computers, laptop computers, smart phones or other computing devices, or combinations thereof. Furthermore, the computer systems 12, 14, 16, 18 may include a plurality of servers, virtual servers, or combinations thereof. The computer systems 12, 14, 16, 18 may be configured to include or execute computer programs and software such as file storage applications, database applications, email or messaging applications, web server applications, or the like, in addition to and/or in conjunction with the computer program and/or software described elsewhere herein.

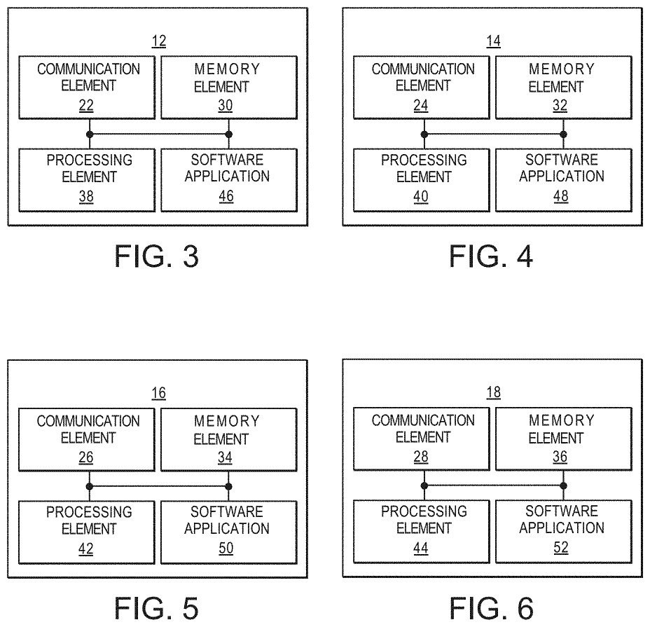

The computer systems 12, 14, 16, 18 may include communication elements 22, 24, 26, 28, memory elements 30, 32, 34, 36, and processing elements 38, 40, 42, 44 executing software applications 46, 48, 50, 52, as depicted in FIGS. 3-6. The communication elements 22, 24, 26, 28 generally allow communication with external systems or devices (such as via the network 20) and/or between the computer systems 12, 14, 16, 18.

The communication elements 22, 24, 26, 28 may include signal or data transmitting and receiving circuits, such as antennas, transceivers, amplifiers, filters, mixers, oscillators, digital signal processors (DSPs), and the like. The communication elements 22, 24, 26, 28 may establish communication wirelessly by utilizing RF signals and/or data that comply with communication standards such as cellular 2G, 3G, 4G, 5G, or LTE, IEEE 802.11 standard such as WiFi, IEEE 802.16 standard such as WiMAX, Bluetooth®, or combinations thereof Alternatively, or in addition, the communication elements 22, 24, 26, 28 may establish communication through connectors or couplers that receive metal conductor wires or cables which are compatible with networking technologies such as ethernet. In certain embodiments, the communication elements 22, 24, 26, 28 may also couple with optical fiber cables. The communication elements 22, 24, 26, 28 may be in communication with or electronically coupled to their respective memory elements 30, 32, 34, 36 and/or processing elements 38, 40, 42, 44.

The memory elements 30, 32, 34, 36 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof In one or more embodiments, the memory elements 30, 32, 34, 36 may be embedded in, or packaged in the same package as, their respective the processing elements. The memory elements 30, 32, 34, 36 may include, or may constitute, a “computer-readable medium.” The memory elements 30, 32, 34, 36 may store the instructions, code, code segments, software, firmware, programs, applications, apps, services, daemons, or the like that are executed by their respective processing elements 38, 40, 42, 44.

The processing elements 38, 40, 42, 44 may include electronic hardware components such as processors. The processing elements 38, 40, 42, 44 may include electronic hardware components such as digital processing units. The processing elements 38, 40, 42, 44 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 38, 40, 42, 44 may generally execute, process, or run instructions, code, code segments, software, firmware, programs, applications, apps, processes, services, daemons, or the like. The processing elements 38, 40, 42, 44 may also include hardware components such as finite-state machines, sequential and combinational logic, and other electronic circuits that may perform the functions necessary for the operation of the current invention. The processing elements 38, 40, 42, 44 may be in communication with the other electronic components through serial or parallel links that include address busses, data busses, control lines, and the like. The processing elements 38, 40, 42, 44 may be in electronic communication with their respective communication elements 22, 24, 26, 28 and memory elements 30, 32, 34, 36.

The network 20 may generally allow communication between the computer systems 12, 14, 16, 18. The network 20 may include local area networks, metro area networks, wide area networks, cloud networks, the Internet, cellular networks, plain old telephone service (POTS) networks, and the like, or combinations thereof. The network 20 may be wired, wireless, or combinations thereof and may include components such as modems, gateways, switches, routers, hubs, access points, repeaters, towers, and the like.

The first computer system 12 may operate on behalf of the consumer reporting agency as defined above and is configured to operate as a data management system that collects data, pseudonymizes certain data, and manages access to data. The first computer system 12 may receive via its communication element 22 data related to consumers and store on its memory element 30 consumer files comprising data associated with the consumers, as defined above. For example, data may include a name of a consumer, an address of a consumer, an occupation of a consumer, a social security number of a consumer, a credit score of a consumer (such as a FICO score), a number of bankruptcies declared by a consumer, a date of such bankruptcy declarations, a number of credit lines associated with a consumer, bank account information related to a consumer, a number of credit lines closed associated with a consumer, a credit utilization metric associated with a consumer, a bank card associated with a consumer, an estimated interest rate across all cards associated with a consumer, an estimated amount of money spent over a time period by a consumer using credit cards, etc.

The first computer system 12 may also be configured to receive via its communication element 22, such as over the network 20, requests for data derived from consumer files, financial institution criteria, pseudonymized data sets, and performance data. For example, the first computer system 12 may receive from the third computer system 16 operating on behalf of the financial institution requests for data sets comprising consumers that qualify under financial institution criteria in relation to marketing campaigns. The first computer system 12 may also be configured to receive from the second computer system 14 data sets comprising subsets of pseudonymized initial data sets corresponding to qualifying subsets of the consumers and unique artificial identifiers included in the pseudonymized initial data sets. The first computer system 12 may also be configured to receive performance data from the third computer system 16, as depicted at step 68 of FIG. 2. The performance data may reflect actions or omissions of at least some of the consumers in the finalized data sets and/or some of the consumers held out in control groups. The performance data may, for example, include at least one of the following datapoint types: a proportion of consumer credit card inquiries following the marketing campaign, a proportion of accounts opened following the marketing campaign, and a measure of credit card usage following the marketing campaign. The performance data may be gathered after a marketing campaign.

The processing element 38 of the first computer system 12 may compare various data sets with the financial institution criteria. For example, the first computer system 12 may compare data derived from the consumer files with financial institution criteria to generate initial data sets comprising subsets of the data of the plurality of consumers corresponding to qualifying subsets of the plurality of consumers, as depicted at step 56 of FIG. 2. The processing element 38 of the first computer system 12 may store the initial data sets in particular portions of the memory element 30 of the first computer system 12 accessible only by the first computer system 12 and/or by submission of an access code. The processing element 38 of the first computer system 12 may be configured to compare re-identified data sets (i.e., data sets received from the second computer system 14) with corresponding financial institution criteria to generate finalized data sets comprising subsets of the re-identified data sets, as depicted at step 60 of FIG. 2. This may ensure that the lists of consumers to be sent to the third computer system 16 and/or the fourth computer system 18 satisfy the financial institution criteria associated with their respective marketing campaigns. The processing element 38 of the first computer system 12 may store the data sets in portions of the memory element 30 of the first computer system 12.

The first computer system 12 may also be configured to pseudonymize data and re-identify data. The processing element of the first computer system 12 may be configured to pseudonymize portions of the data by, for example, removing at least some data of a consumer file and/or substituting at least some of the data with artificial identifiers. Pseudonymization is preferably performed such that additional information is required to re-identify the consumers. For example, a unique artificial identifier (corresponding to PIN #2 in FIG. 2) may be assigned to each consumer for replacement of a unique identifier (corresponding to PIN #1 in FIG. 2) such as a name, social security number or the like. The unique artificial identifier may be re-identified to the consumer using a key. The key may comprise an index or look-up table correlating the artificial identifier with the unique identifier for re-identification of the consumer.

The key and/or look-up table may only be accessible by the first computer system 12, or in one or more embodiments, only a third party may have access to, or have knowledge of, the key and/or look-up table. For example, the key and/or look-up table may be generated by the third party. The pseudonymization of the data may also include automatically removing any data associated with a consumer that could be used to identify the consumer, such as a social security number, a residential address, etc. One of ordinary skill will appreciate that pseudonymization may be performed by such replacement and/or deletion procedures within a particular data set so that each consumer reflected in the data set may not be identified uniquely, whether by reference to the consumer's pseudonymized record or to other data within the pseudonymized data set, without additional information outside the pseudonymized data set (e.g., the key for re-identifying the consumer),In this manner, the second computer system 14 preferably receives pseudonymized data (only) from the first computer system 12 with respect to marketing campaigns, and is not able to re-identify such pseudonymized data, as depicted in step 57 of FIG. 2.

For example, the first computer system 12 may pseudonymize portions of initial data sets for transmission to the second computer system 14. The processing element of the first computer system 12 may also be configured to pseudonymize finalized data sets to form pseudonymized finalized data sets and to store such data sets in portions of the memory element 30 of the first computer system 12. The first computer system 12 may be configured to pseudonymize the finalized data sets using the same keys or look-up tables so that the unique identifier for each consumer is consistent among all data sets associated with a particular marketing campaign. The first computer system 12 may also be configured to pseudonymize performance data using the same key or look-up table so that the unique identifier for each consumer is consistent, as depicted at step 70 of FIG. 2. The processing element 38 of the first computer system 12 may be configured to re-identify consumers in the data sets received from the second computer system 14 using the key or look-up table to generate re-identified data sets.

The first computer system 12 may be configured to transmit data sets to the other computer systems 14, 16, 18 via the network 20 and/or the first computer system 12 may be configured to provide the computer systems 14, 16, 18 access to the data upon submission of a proper access code. For example, the first computer system 12 may transmit the pseudonymized data sets to the second computer system 14. Additionally or alternatively, the first computer system 12 may provide access to portions of its memory element 30 storing the pseudonymized data sets. The communication element of the first computer system 12 may transmit an access code for accessing only a particular portion of the memory element 30 storing a particular data set to the second computer system 14. The first computer system 12 may also be configured to transmit pseudonymized finalized data sets to the second computer system 14 or make portions of the memory element 30 storing the pseudonymized (only) finalized data sets accessible by the second computer system 14 via an access code. The first computer system 12 may be configured to transmit pseudonymized performance data to the second computer system 14 or make portions of the memory element 30 storing pseudonymized (only) performance data accessible by the second computer system 14 via an access code.

Additionally, the communication element 22 of the first computer system 12 may be configured to transmit finalized data sets to the third computer system 16 and/or the fourth computer system 18. Additionally or alternatively, the first computer system 12 may allow the third computer system 16 to access the portions of its memory element 30 having the finalized data sets. For example, the first computer system 12 may be configured to provide access codes to the third computer system 16 for accessing particular portions of the memory element 30 having particular finalized data sets. The access codes sent to the third computer system 16 may be different than the access codes provided to the second computer system 14.

The second computer system 14 may operate on behalf of the payment card network as defined above and is configured to process pseudonymized data to provide better filters for selecting consumers for marketing campaigns. The second computer system 14 is generally configured to receive, via its communication element 24, pseudonymized data from the first computer system 12. For example, the second computer system 14 may receive pseudonymized initial data sets comprising pseudonymized data of consumers derived from respective consumer files, pseudonymized final data sets (as depicted at step 64 of FIG. 2), and pseudonymized performance data. The second computer system 14 may be configured to submit access codes to the first computer system 12 in order to access the pseudonymized data sets from the first computer system 12. The pseudonymized data of each consumer may include a unique artificial identifier for the consumer. The second computer system 14 may store such data sets on its memory element 32. The pseudonymized data may, for each consumer, comprise a credit score associated with one of the unique identifiers (such as a FICO score), a number of bankruptcies declared associated with one of the unique identifiers, date(s) of such bankruptcy declarations associated with one of the unique identifiers, a number of credit lines associated with one of the unique identifiers, bank account information associated with one of the unique identifiers, a number of credit lines closed associated with one of the unique identifiers, a credit utilization metric associated with one of the unique identifiers, a number of bank cards associated with one of the unique identifiers, an estimated interest rate across all cards associated with one of the unique identifiers, an estimated amount of money spent over a time period using credit cards associated with one of the unique identifiers, etc.

The processing element 40 of the second computer system 14 may be configured to compare the pseudonymized data of consumers represented by unique identifiers in received data sets with payment card network criteria, as depicted at step 58 of FIG. 2. The payment card network criteria may be associated with one or more marketing campaigns. Qualifying consumers may be reflected in or assigned to filtered data sets comprising a subset of the pseudonymized data sets received from the first computer system 12 corresponding to qualifying subsets of the consumers represented by unique artificial identifiers included in the received data sets. The payment card network criteria may comprise a range of allowable credit scores (such as a FICO score), a maximum number of bankruptcies declared by a consumer, a maximum number of days since a bankruptcy declaration, a maximum number of credit lines, a maximum number of credit lines closed, a maximum credit utilization metric, a maximum number of bank cards, a maximum estimated interest rate across all cards, a minimum estimated amount of money spent over a time period using credit cards, or the like. This enables incremental analysis of portions of the payment card network criteria in order to generate the best profiles for certain marketing campaigns.

The processing element 40 of the second computer system 14 may also be configured to designate control groups. The second computer system 14 may be configured to randomly designate to a control group unique identifiers from filtered data sets, i.e., randomly selected unique identifiers having pseudonymized data that satisfied the payment card network criteria. One of ordinary skill will appreciate that a variety of methods for designating a control group from among pseudonymized data may be utilized within the scope of the present invention. The processing element 40 of the second computer system 14 may also be configured to send one or more of the filtered data sets to the first computer system 12, as depicted in step 59a of FIG. 2. The processing element 40 of the second computer system 14 may also be configured to send a risk audit file derived from the one or more of the filtered data sets to the third computer system 16, as depicted in step 59b of FIG. 2.

The processing element 40 of the second computer system 14 may be configured to receive the performance data, as depicted at step 72 of FIG. 2 The processing element 40 of the second computer system 14 may be configured to analyze the performance data. For example, the second computer system 14 may compare performance data of those consumers who received firm credit offers against that of those consumers who were withheld in a control group to generate an indicator of the efficacy of the marketing campaign. The second computer system 14 may also be configured to determine a correlation between at least some of the pseudonymized data and/or payment card criteria, on the one hand, and at least some of the performance data, on the other hand, to generate a profile. By receiving pseudonymous performance data and analyzing the performance data in light of the criteria applied and control group via the second computer system 14, incremental analysis of marketing campaign data is enabled within corresponding legal confines (e.g., without violating the FRCA).

The communication element of the second computer system 14 may be configured to transmit data sets to and receive data sets from the first computer system 12.

The third computer system 16 operates on behalf of the financial institution as defined above. The financial institution may provide offers of credit to consumers. The communication element 26 of the third computer system 16 may be configured to transmit financial institution criteria to the first computer system 12, as depicted at step 54 of FIG. 2. The financial institution criteria may comprise desired ranges and/or limits on certain types of the data described above, such as a credit score range, a maximum number of credit lines, etc. Each marketing campaign may involve different financial institution criteria.

The third computer system 16 may be configured to receive from the first computer system 12 data sets reflecting consumers having data that satisfy the financial institution criteria and the payment card network criteria associated with respective marketing campaign(s), as depicted at step 62 of FIG. 2. In other words, the third computer system 16 may be configured to receive consumer reports, as defined above, having personal information of certain qualified consumers for sending firm offers of credit to the qualified customers. In one or more embodiments, the third computer system 16 may be configured to submit an access code to the first computer system 12 in order to access data sets from the first computer system 12. The third computer system 16 may be configured to transmit the data sets to the fourth computer system 18 for processing and generation of marketing material, such as direct mail, as depicted at step 66 of FIG. 2.

The third computer system 16 may also be configured to collect and compile performance data related to the marketing campaigns, as depicted at step 68 of FIG. 2. The third computer system 16 may be configured to send data, such as performance data, to the first computer system 12, which may, in turn, pseudonymize the performance data and pass it on to the second computer system 14.

The fourth computer system 18 operates on behalf of, for example, the mail house. The fourth computer system 18 may be configured to receive a list of consumers and their addresses for transmitting a firm offer of credit associated with a marketing campaign. The mail house may send firm offers of credit via physical mail and/or through other means, such as targeted advertising or email.

The system may include additional, less, or alternate functionality and/or device(s), including those discussed elsewhere herein.

### EXEMPLARY METHOD

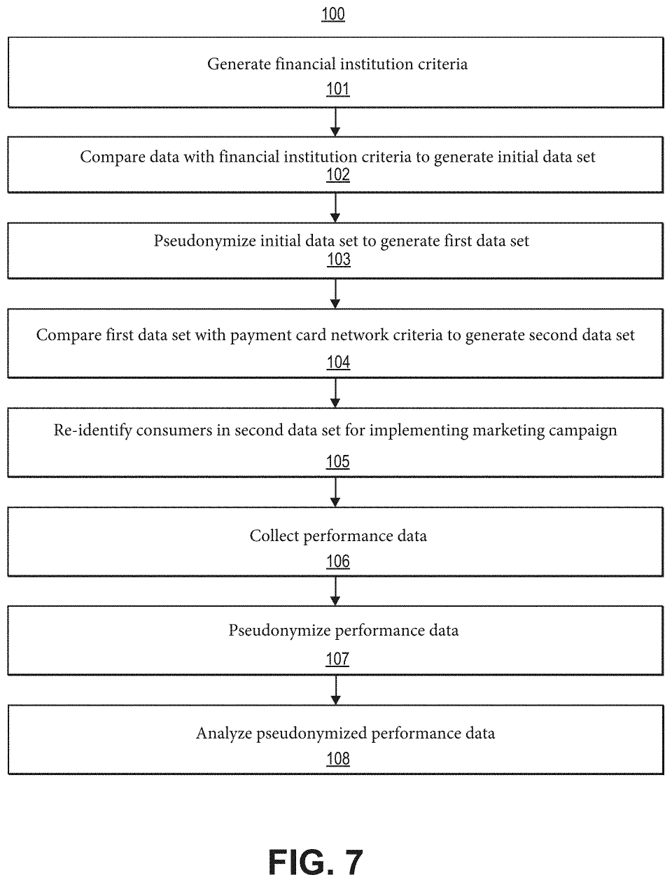

FIG. 7 depicts a listing of steps of an exemplary computer-implemented method 100 for filtering targets for marketing campaigns and analyzing performance of the marketing campaigns. The steps may be performed in the order shown in FIG. 7, or they may be performed in a different order. Furthermore, some steps may be performed concurrently as opposed to sequentially. In addition, some steps may be optional.

The computer-implemented method 100 is described below, for ease of reference, as being executed by exemplary devices and components introduced with the embodiments illustrated in FIGS. 1-6. For example, the steps of the computer-implemented method 100 may be performed by the computers 12, 14, 16, 18 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 101, financial institution criteria associated with a marketing campaign is generated. In one or more embodiments, the financial institution criteria may be generated at a third computer system operating on behalf of a financial institution. The financial institution criteria may be sent from the third computer system to a first computer system operating on behalf of a consumer reporting agency.

The criteria may correspond to the type of credit or credit card to be offered to the consumer. For example, the criteria may include ranges describing permitted values for datapoints included in data regarding consumers, such as a credit score range. The criteria may also or alternatively describe limits for permitted number, duration, frequency or other aspects of other datapoints in consumer data, such as where the criteria excludes consumers having declared a defined number of recent bankruptcies, consumers that are already customers of the financial institution, or otherwise excludes or includes consumers on the basis of consumer data.

One of ordinary skill will also appreciate that the criteria may be taken in combination—such as where a weighted combination or decision tree are evaluated against a consumer file in its entirety to determine whether the criteria are met. In such embodiments, an unfavorable value in a consumer's file on a first datapoint may be overcome with a sufficiently favorable value on a second datapoint, or vice versa.

Referring to step 102, the financial institution criteria is compared with data derived from consumer files to generate an initial data set. In one or more embodiments, the first computer system operating on behalf of the consumer reporting agency may receive and process the financial institution criteria from the third computer system. The consumer file or data may comprise a record corresponding to each consumer, each record including a name, an address, an occupation, a social security number, a credit score (such as a FICO score), a number of bankruptcies declared, corresponding date(s) of such bankruptcy declaration(s), a number of credit lines, bank account information, a number of credit lines closed, a credit utilization metric, a bank card, an estimated interest rate across all associated cards, an estimated amount of money spent over a time period, and other datapoints. The initial data set may comprise a subset of the data derived from the consumer files and records, and may correspond to a subset of the consumers having data that meet the financial institution criteria.

Referring to step 103, the data associated with each consumer represented in the initial data set may be pseudonymized to generate a first data set. The consumer data may be pseudonymized by, for example, performing substitutions and/or deletions on datapoints that comprise unique consumer identifiers (e.g., name, social security number, address, or the like, or any combination of information that may together uniquely identify the consumer). Pseudonymization of the data may include automatically removing from the pseudonymized data subset any data associated with a consumer that could, alone or in combination, be used to identify the consumer, such as a social security number, a residential address, or the like.

Data that may remain in each record following pseudonymization preferably does not, taken alone or in combination, constitute personally identifiable information. For example, the following datapoints—each contained in a record keyed with a unique artificial identifier corresponding to an individual consumer—may be left untouched by substitution/deletion according to the pseudonymization operations: credit score (such as a FICO score), number of bankruptcies declared, date(s) of such bankruptcy declaration(s), number of credit lines, bank account information, number of credit lines closed, credit utilization metric(s), number of bank cards, estimated interest rate across all cards, estimated amount of money spent over a time period using associated credit cards, and/or other information that may be considered relevant to fiscal responsibility.

The substitution and/or deletion operation(s) may, and preferably will, obscure consumer identity to the extent that additional information is required to re-identify the consumers. To facilitate re-identification, the pseudonymization may include assigning a unique artificial identifier to each consumer and relating the pseudonymized unique consumer identifier(s) to corresponding unique artificial identifiers within a key or look-up table for later re-identification of the consumer. The key and/or look-up table may only be accessible by the first computer system, or in one or more embodiments, only a third party may have access to, or have knowledge of, the key and/or look-up table. For example, the key and/or look-up table may be generated by the third party.

The first data set may be transmitted to a second computer system operating on behalf of a payment card network. Additionally or alternatively, a first access code may be transmitted to the payment card network for obtaining access to the pseudonymized (only) data set(s).

Referring to step 104, the first data set may be compared with payment card network criteria. For example, the first data set may be received by the payment card network. In one or more embodiments, the first data may be received by the second computer system. Alternatively or additionally, the first access code may be sent from the second computer system to the first computer system to access the first data set comprising pseudonymized (only) data.

The payment card network criteria may be applied to the first data set via the second computer system for incremental analysis purposes. For example, the pseudonymized data of each of the consumers may be compared with payment card network criteria to generate a second data set comprising a subset of the first data set corresponding to a qualifying subset of the consumers, the qualifying subset of the consumers again being represented in pseudonymized records including corresponding unique artificial identifiers.

The payment card network criteria may be different than the financial institution criteria. The payment card network criteria may comprise a range of allowable credit scores (such as a FICO score), maximum a number of bankruptcies declared by a consumer, a maximum number of days since a bankruptcy declaration, a maximum number of credit lines, a maximum number of credit lines closed, a maximum credit utilization metric, a maximum number of bank cards, a maximum estimated interest rate across a number of lines of credit, a minimum estimated amount of money spent over a time period using credit cards, other information relating to fiscal responsibility of consumers and/or any combination of the foregoing.

This step 104 may additionally include designating a control group comprising one or more of the consumers represented in the first data set. In one or more embodiments, records may be randomly selected from the second data set, which contains records for those consumers that satisfied the payment card network criteria. In one or more embodiments, a portion of the records comprising the first data set may be segmented and screened separately with the payment card network criteria to populate the control group. One of ordinary skill will appreciate that operations for designating a control group may be variously ordered within the scope of the present invention.

At least a portion of the second data set may be transmitted from the second computer system to the first computer system. For example, a first list of the unique identifiers corresponding to qualifying consumers may be sent along with a second list of the unique identifiers corresponding to the control group.

Referring to step 105, consumers in the second data set may be re-identified for implementing the marketing campaign. The second data set may be received by the consumer reporting agency. For example, the second data set may be received at the first computer system from the second computer system. Consumers in the second data set may be re-identified at the first computer system to generate a third data set. The consumers may be re-identified using the key or look-up table generated in connection with generation of the first data set, at least in part by matching the unique artificial identifiers to retrieve name, address and other personally identifiable information of corresponding consumers.

The third data set may exclude the consumers corresponding to the unique identifiers designated in the control group. The data associated with the consumers of the third data set may again be compared with the financial institution criteria and/or additional financial institution criteria to generate a fourth data set comprising a subset of the third data set. In one or more embodiments, the fourth data set may be pseudonymized to generate a pseudonymized fourth data set. The fourth data set may be pseudonymized using the key or look-up table generated in connection with generation of the first data set so that the unique identifier for each consumer is consistent across all of the data sets.

This step 105 may include transmitting the fourth data set to the financial institution and/or mail house for implementing the marketing campaign. In one or more embodiments, the fourth data set is transmitted from the first computer system to the third computer system operating on behalf of the financial institution and/or the fourth computer system operating on behalf of the mail house. In one or more embodiments, the fourth data set may be sent from the third computer system to the fourth computer system. The fourth data set may be used to send firm offers of credit to the consumers in the fourth data set. In one or more embodiments, transmitting the fourth data set may include allowing the third computer system to access the fourth data set using a second access code. The second access code may be different than the first access code to ensure different levels of access to data derived from consumer files and to ensure the second computer system only receives pseudonymized data. The second access code may be submitted to the first computer system by the third computer system in order to access the fourth data set.

The financial institution and/or mail house may, according to the contact information included in the fourth data set, prepare and mail or otherwise transmit credit offers under the marketing campaign.

This step 105 may also include transmitting the pseudonymized fourth data set to the payment card network. In one or more embodiments, the pseudonymized fourth data set is sent from the first computer system to the second computer system. Transmitting the pseudonymized fourth data set may include submitting the first access code at the first computer system via the second computer system.

By accessing the pseudonymized fourth data set at the second computer system, an accurate list of targeted consumers (though pseudonymized and represented by unique artificial identifiers) can be maintained at the second computer system for more accurate incremental analysis.

Referring to step 106, first performance data reflecting actions or omissions of at least some of the consumers represented in the fourth data set may be collected. In one or more embodiments, the financial institution tracks and/or collects the performance data at the third computer system. Second performance data reflecting actions or omissions of at least some of the consumers represented in the control group may also be collected at the third computer system. The first performance data and the second performance data may be transmitted from the third computer system to the first computer system.

Referring to step 107, the first performance data and the second performance data are received and pseudonymized. The performance data may be received at and pseudonymized by the first computer system. The first performance data and the second performance data may be pseudonymized to include the unique artificial identifiers corresponding to at least some of the consumers represented in the first data set. The performance data may be pseudonymized using the key or look-up table generated in connection with generation of the first data set so that the unique artificial identifiers are consistent across all data sets. The pseudonymized first performance data and the pseudonymized second performance data may be transmitted from the first computer system to the second computer system. This may include allowing the second computer system to access the pseudonymized performance data using the first access code.

Referring to step 108, the pseudonymized first performance data and the pseudonymized second performance may be received and analyzed. In one or more embodiments, the performance data may be received and processed by the second computer system. Analysis of the pseudonymized performance data may include incremental analysis. For example, the pseudonymized first performance data may be compared against the pseudonymized second performance data to generate an indicator of the efficacy of the marketing campaign. For example, if the pseudonymized first performance data reflects a statistically significant higher number of accounts opened than appears in the pseudonymized second performance data, then the indicator may include a high account generation indicator associated with the marketing campaign versus the control group. One of ordinary skill will appreciate that a variety of actions or omissions of consumers may be analyzed, and a corresponding variety of conclusions drawn, within the scope of the present invention.

Additionally, a correlation may be determined between at least some of the pseudonymized data associated with consumers not in the control group, on the one hand, and at least some of the pseudonymized first performance data associated with such consumers, on the other hand, to generate a profile. As an addition to the previous example, a statistically significant difference in number of accounts opened between the pseudonymized first performance data compared against the pseudonymized second performance data may yield a statistically strong correlation between new accounts opened and a portion of the pseudonymized data, such as, for example, a certain credit score range. In one or more embodiments, the payment card network criteria may be adjusted based on the profile, the correlation, and/or the indicator.

For example, if a statistically strong correlation is found between positive (or desired) performance data, such as a number of new applications received and/or a number of new accounts opened, and a first set of one or more values or ranges reflected in the pseudonymized data, such as a credit score range and/or a number of credit lines open, then the payment card network criteria for future marketing campaigns may be broadened or otherwise adjusted in an effort to include more people having corresponding pseudonymized data matching or similar to the first set of one or more correlated values or ranges. Additionally or alternatively, if a statistically strong correlation is found between negative (or undesirable) performance data, such as a low number of new applications received and/or a low number of new accounts opened, and a second set of one or more values or ranges reflected in the pseudonymized data, such as a credit score range and/or a number of credit lines open, then the payment card network criteria for future marketing campaigns may be narrowed or otherwise adjusted in an effort to exclude people having corresponding pseudonymized data matching or similar to the second set of one or more correlated values or ranges.

The method may include additional, less, or alternate steps and/or device(s), including those discussed elsewhere herein.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although consumer operations of one or more methods are illustrated and described as separate operations, one or more of the consumer operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim (s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method of filtering targets for marketing campaigns, the method comprising:
receiving, at a first computer system operating on behalf of a payment card network, a first data set comprising pseudonymized data of a plurality of consumers derived from respective consumer files, the pseudonymized data of each consumer including a unique artificial identifier for the consumer, the first data set being received from a second, independent computer system storing keys configured to re-identify at least some of the pseudonymized data of the first data set;
comparing, at the first computer system, the pseudonymized data of each of the consumers with payment card network criteria to generate a second data set comprising a subset of the first data set corresponding to a qualifying subset of the consumers and unique artificial identifiers included in the first data set; and
transmitting the second data set from the first computer system to the second computer system.

2. The method of claim 1, further comprising designating a control group comprising one or more of the consumers represented in the first data set, the data of the one or more consumers of the control group having satisfied the payment card network criteria.

3. The method of claim 2, further including receiving at the first computer system, from the second computer system, a third data set comprising the unique artificial identifiers of a subset of the consumers represented in the second data set.

4. The method of claim 2, further comprising—
receiving, at the first computer system, first performance data reflecting actions or omissions of at least some of the consumers represented in the second data set but not represented in the control group, the first performance data being gathered after a marketing campaign and being pseudonymized to include the unique artificial identifiers corresponding to the at least some of the consumers represented in the second data set that are not represented in the control group;
receiving, at the first computer system, second performance data reflecting actions or omissions of at least some of the consumers represented in the control group, the second performance data being gathered after the marketing campaign and being pseudonymized to include the unique artificial identifiers corresponding to the at least some of the consumers represented in the control group;
comparing the first performance data against the second performance data to generate an indicator of the efficacy of the marketing campaign.

5. The method of claim 2, wherein designating the control group comprises randomly selecting from the consumers reflected in the second data set.

6. The method of claim 4, further comprising determining a correlation between at least some of the pseudonymized data corresponding to the consumers reflected in the second data set but not reflected in the control group, on the one hand, and at least some of the first performance data corresponding to the consumers reflected in the second data set but not reflected in the control group, on the other hand, to generate a profile.

7. The method of claim 4, wherein the first performance data and the second performance data both include at least one of the following datapoint types: a proportion of consumer credit card inquiries following the marketing campaign, a proportion of accounts opened following the marketing campaign, and a measure of credit card usage following the marketing campaign.

8. The method of claim 1, wherein the first data set is generated based on financial institution criteria.

9. The method of claim 1, wherein the pseudonymized data comprises data elements relating to one or more of the following types: credit score, number of open lines of credit, number of closed lines of credit, credit utilization, use of a credit monitoring service, existence of an account with a financial institution, estimated interest rate across a number of lines of credit, and amount spent in a given year on credit cards.

10. A computer-implemented method of providing targets for marketing campaigns, the method comprising:
receiving, at a first computer system operating on behalf of a consumer reporting agency, financial institution criteria from a second, independent computer system operating on behalf of a financial institution;
comparing, at the first computer system, data of a plurality of consumers derived from respective consumer files with the financial institution criteria to generate an initial data set comprising a subset of the data of the plurality of consumers corresponding to a qualifying subset of the plurality of consumers;
pseudonymizing, at the first computer system, the data associated with each consumer of the initial data set with a key to generate a first data set, the pseudonymized data of each consumer represented in the initial data set including a unique artificial identifier;
transmitting the first data set from the first computer system to a third, independent computer system operating on behalf of a payment card network;
receiving, at the first computer system from the third computer system, a second data set comprising a subset of the first data set corresponding to a qualifying subset of the consumers and unique artificial identifiers included in the first data set;
re-identifying, at the first computer system, consumers in the second data set using the key to generate a third data set; and
transmitting the third data set to the second computer system.

11. The method of claim 10, further comprising comparing, at the first computer system, updated data associated with each of the consumers of the second data set with the financial institution criteria to generate the third data set comprising a subset of the second data set corresponding to a qualifying subset of the consumers and unique artificial identifiers included in the second data set.

12. The method of claim 11, further comprising pseudonymizing, at the first computer system, the data associated with each consumer of the third data set with the key to generate a pseudonymized third data set, the pseudonymized data of each consumer including a unique artificial identifier for the consumer.

13. The method of claim 12, further comprising transmitting the pseudonymized third data set from the first computer system to the third computer system.

14. The method of claim 13, wherein the step of transmitting the pseudonymized third data set to the third computer system comprises providing a first access code to the third computer system that grants access to a database storing the pseudonymized third data set.

15. The method of claim 10, wherein the step of transmitting the third data set to the second computer system comprises providing a second access code to the second computer system that grants access to a database storing the third data set.

16. The method of claim 10, wherein the second data set comprises a control group comprising one or more of the consumers represented in the first data set, the data of the one or more consumers of the control group having satisfied payment card network criteria.

17. A first computer system operating on behalf of a payment card network and configured to filter targets for marketing campaigns, the first computer system comprising a non-transitory computer-readable medium having computer readable program code for instructing a processing element to perform the following steps:
receive a first data set comprising pseudonymized data of a plurality of consumers derived from their respective consumer files, the pseudonymized data of each consumer including a unique artificial identifier for the consumer, the first data set being received from a second, independent computer system storing keys configured to re-identify at least some of the pseudonymized data of the first data set;
compare the data of each of the consumers with payment card network criteria to generate a second data set comprising a subset of the first data set corresponding to a qualifying subset of the consumers and unique artificial identifiers included in the first data set; and
transmit the second data set from the first computer system to the second computer system.

18. The system of claim 17, wherein the non-transitory computer-readable medium further includes computer readable program code for instructing the processing element to designate a control group comprising one or more of the consumers represented in the first data set, the data of the one or more consumers of the control group having satisfied the payment card network criteria.

19. The system of claim 18, wherein the non-transitory computer-readable medium further includes computer readable program code for instructing the processing element to perform the following steps—
receive first performance data reflecting actions or omissions of at least some of the consumers represented in the second data set but not represented in the control group, the first performance data being gathered after a marketing campaign and being pseudonymized to include the unique artificial identifiers corresponding to the at least some of the consumers represented in the second data set that are not represented in the control group;
receive second performance data reflecting actions or omissions of at least some of the consumers represented in the control group, the second performance data being gathered after the marketing campaign and being pseudonymized to include the unique artificial identifiers corresponding to the at least some of the consumers represented in the control group;
compare the first performance data against the second performance data to generate an indicator of the efficacy of the marketing campaign

20. The system of claim 19, wherein the non-transitory computer-readable medium further includes computer readable program code for instructing the processing element to determine a correlation between at least some of the pseudonymized data corresponding to the consumers reflected in the second data set but not reflected in the control group, on the one hand, and at least some of the first performance data corresponding to the consumers reflected in the second data set but not reflected in the control group, on the other hand, to generate a profile.
